(19) United States
(12) Patent Application Publication
(10) Pub. No.: US 2015/0073977 A1
(43) Pub. Date: Mar. 12, 2015

(54) MERCHANT TRACKING AND ANALYSIS TOOL

(71) Applicant: Bank of America Corporation, Charlotte, NC (US)

(72) Inventors: Debashis Ghosh, Charlotte, NC (US); Sreedevi Gummuluri, Charlotte, NC (US); Sudeshna Banerjee, Waxhaw, NC (US); Yanghong Shao, Charlotte, NC (US); Kurt Newman, Matthews, NC (US); David Joa, Pacifica, CA (US); Thayer Allison, Charlotte, NC (US)

(21) Appl. No.: 14/541,936

(22) Filed: Nov. 14, 2014

Related U.S. Application Data
(63) Continuation of application No. 12/475,908, filed on Jun. 1, 2009.

(51) Int. Cl. G06Q 40/02

(52) U.S. Cl. CPC G06Q 40/025
USPC 705/38

(57) ABSTRACT

Transaction data is processed using a store number that is associated with a merchant. By analyzing sales of a merchant by store, a financial institution can better assess the financial health of a merchant. The financial institution can subsequently evaluate different value propositions that may be offered to the merchant or a consumer. The store numbers are extracted from the transaction entries so that a performance metric can be determined by store locations of the merchant. Consequently, the financial institution can determine the financial health of the merchant based on individual stores rather than on the total sales of the merchant. Different value propositions can be offered by the financial institution to a merchant or a consumer of the merchant based on an analysis of the transaction data. Transaction data for different merchants and different geographic areas can be compared to identify potential customers for the financial institution.

### CROSS-REFERENCE TO RELATED APPLICATION

This application is a continuation of and claims priority to U.S. patent application Ser. No. 12/475,908, filed Jun. 1, 2009, and entitled “MERCHANT TRACKING AND ANALYSIS TOOL,” the disclosure of which is incorporated by reference herein in its entirety and made part hereof.

### FIELD OF THE INVENTION

Aspects of the invention generally relate to tracking and analyzing merchant transactions on a store basis.

### BACKGROUND

In order to determine the viability of financing a merchant, a financial institution, e.g., a bank, often analyzes the merchant's productivity on total sales rather than comparable store sales. However, total sales may not be an accurate indicator of the merchant's financial health. A merchant may increase the number of stores in order to increase the total sales while the same store sales decrease. For example, the merchant may saturate a geographical area with stores so that the merchant's own stores are competing with each other. Such a scenario may be indicative of a poor financial situation that a financial institution typically wants to avoid.

Even if a merchant provides sales information, a bank is often aware of the information only after the merchant publically releases it. Consequently, a bank may first recognize that the merchant has financial problems only after investing in the merchant. Moreover, merchants that are privately-held may not publically release sales information at all.

### BRIEF SUMMARY

Aspects of the invention address one or more of the issues mentioned above by disclosing methods, computer readable media, and apparatuses for processing transaction data using a store number that is associated with a merchant. By analyzing sales of a merchant by store, a financial institution, e.g., a bank, can better assess the financial health of a merchant. The financial institution can subsequently evaluate different value propositions that may be offered to the merchant or a consumer.

With another aspect of the invention, transaction data for a merchant is accessed. The store numbers are extracted for the transaction entries so that a performance metric can be determined by store locations of the merchant. Consequently, a financial institution can determine the financial health of the merchant based on individual stores rather than on the total sales of the merchant.

With another aspect of the invention, different value propositions can be offered by a financial institution to a merchant or a consumer of the merchant. The different value propositions can be evaluated using an analysis of the transaction data. Value propositions may include merchant line management, merchant prospecting, customization of consumer rewards, and product tie-ins with merchants.

With another aspect of the invention, transaction data for different merchants and different geographic areas can be compared to identify potential customers for a financial institution.

Aspects of the invention may be provided in a computer-readable medium having computer-executable instructions to perform one or more of the process steps described herein.

These and other aspects of the invention are discussed in greater detail throughout this disclosure, including the accompanying drawings.

### BRIEF DESCRIPTION OF THE DRAWINGS

The present invention is illustrated by way of example and not limited in the accompanying figures in which like reference numerals indicate similar elements and in which:

FIG. 1 shows an illustrative operating environment in which various aspects of the invention may be implemented.

FIG. 2 is an illustrative block diagram of workstations and servers that may be used to implement the processes and functions of certain aspects of the present invention.

FIG. 3 shows a system for accessing and analyzing transaction data in accordance with an aspect of the invention.

FIG. 4 shows a flow diagram for processing sales data for different store locations of a merchant in accordance with an aspect of the invention.

FIG. 5 shows a flow diagram for analyzing sales data in accordance with an aspect of the invention.

FIG. 6 shows a flow diagram for extracting store number information form transaction data in accordance with an aspect of the invention.

### DETAILED DESCRIPTION

In accordance with various aspects of the invention, methods, computer-readable media, and apparatuses are disclosed in which transaction data is processed using store numbers of a merchant. A financial institution, e.g., a bank, may consequently evaluate different value propositions that nay be offered to the merchant or a consumer.

According to aspects of the invention, the financial viability of a merchant may be assessed using merchant store numbers for associated transactions. Consequently, a financial institution can examine merchant performance with internal proprietary data with lesser reliance on external sources. Analyzer 303 can track consumer spending at same stores and gauge a company's performance ahead of their financial releases. Based on this information, a financial institution can make strategic decisions regarding risk assessment and line management to determine a line of credit that can be offered to the merchant.

With an aspect of the invention, same-store-sales over time can be tracked. Same-store-sales may measure the growth in sales of stores that have been open for a year or more. Retailers can increase their revenue either by increasing revenues at an existing store or by opening new stores to increase volumes. Rising comparable sales may indicate that sales are rising at the same set of stores without the added cost of opening a new store. Merchants and store numbers that cease appearing in transaction data may indicate potential distress for the merchant. Additionally, new merchants can be identified as new stores and associated business names start to appear in transaction data.

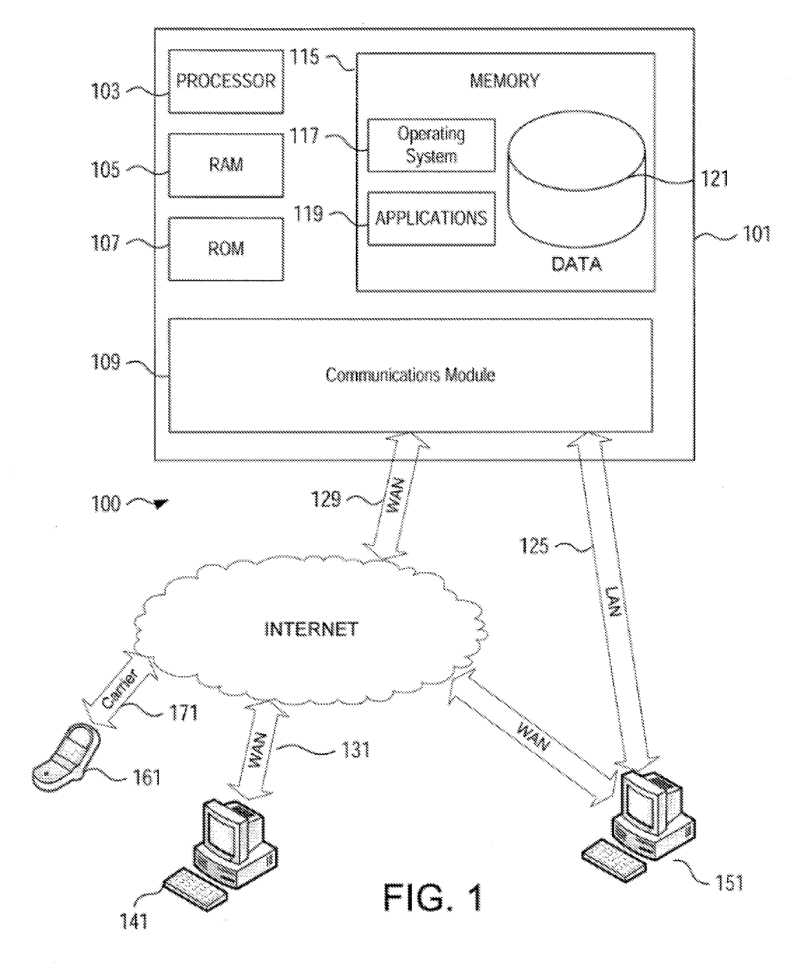

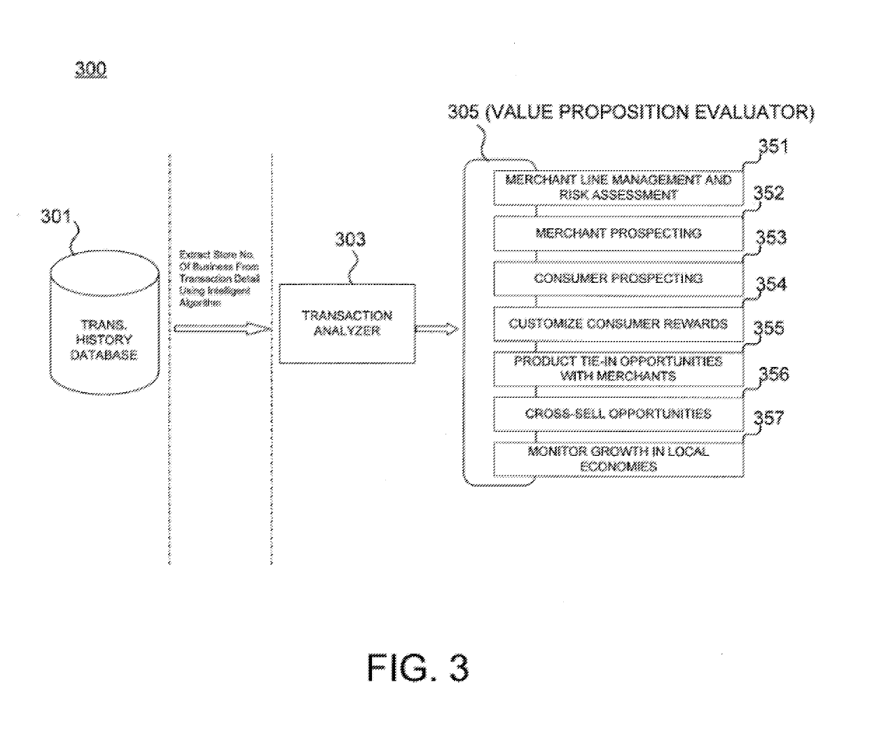

FIG. 1 illustrates an example of a suitable computing system environment 100 (e.g., for supporting system 300, process 400, process 500, and process 600 as shown in FIGS. 3, 4, 5, and 6, respectively) that may be used according to one or more illustrative embodiments. The computing system environment 100 is only one example of a suitable computing environment and is not intended to suggest any limitation as to the scope of use or functionality of the invention. The computing system environment 100 should not be interpreted as having any dependency or requirement relating to any one or combination of components shown in the illustrative computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including RAM 105, ROM 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, and the like to digital files.

Although not shown, RAM 105 may include one or more are applications representing the application data stored in RAM memory 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Alternatively, some or all of the computer executable instructions for computing device 101 may be embodied in hardware or firmware (not shown).

Database 121 may provide centralized storage of transaction data (e.g., sales data for different merchants for different store locations). Processor 103 may access transaction data from database 121 (corresponding to database 301 as shown in FIG. 3) and process the transaction data by store number as performed by transaction analyzer 303 as further discussed. Processor 103 may further evaluate different value propositions as performed by evaluator 305.

Computing device 101 may operate in a networked environment supporting connections to one or more remote computing devices, such as branch terminals 141 and 151. The branch computing devices 141 and 151 may be personal computing devices or servers that include many or all of the elements described above relative to the computing device 101. Branch computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 is connected to the LAN 825 through a network interface or adapter in the communications module 109. When used in a WAN networking environment, the server 101 may include a modem in the communications module 109 or other means for establishing communications over the WAN 129, such as the Internet 131. It will be appreciated that the network connections shown are illustrative and other means of establishing a communications link between the computing devices may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages. The network connections may also provide connectivity to a CCTV or image/iris capturing device.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, one of ordinary skill in the art will appreciate that various aspects described herein may be embodied as a method, a data processing system, or as a computer-readable medium storing computer-executable instructions. For example, a computer-readable medium storing instructions to cause a processor to perform steps of a method in accordance with aspects of the invention is contemplated. For example, aspects of the method steps disclosed herein may be executed on a processor on a computing device 101. Such a processor may execute computer-executable instructions stored on a computer-readable medium.

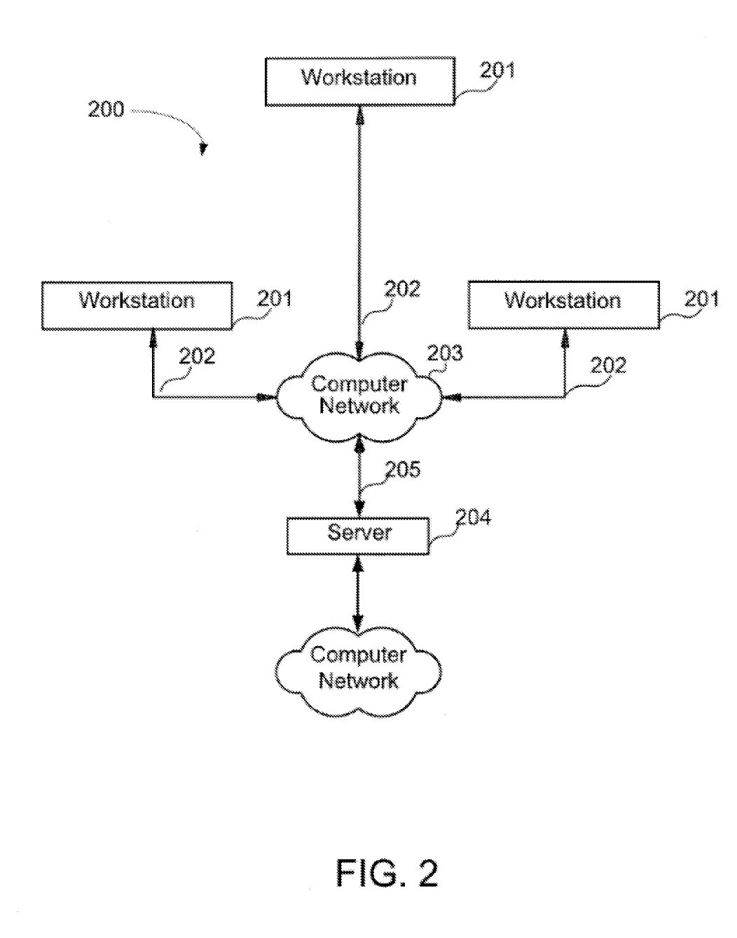

Referring to FIG. 2, an illustrative system 200 for implementing methods according to the present invention is shown. As illustrated, system 200 may include one or more workstations 201. Workstations 201 may be local or remote, and are connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, and the like. Connectivity may also be supported to a CCTV or image/iris capturing device.

As understood by those skilled in the art, the steps that follow in the Figures may be implemented by one or more of the components in FIGS. 1 and 2 and/or other components, including other computing devices.

FIG. 3 shows system 300 for accessing and analyzing transaction data in accordance with an aspect of the invention. System 300 includes transaction database 301 that stores transaction information. Database 300 may store transaction history including debit card, credit card, bill payment history entries for customers of a financial institution. From the entries, analyzer 303 analyzes the customer transaction information, where a customer may be a consumer of various merchants and where a merchant may also be a customer or a potential customer of the financial institution. Consequently, as will be further discussed, value proposition evaluator 305 uses the results of the analysis to evaluate different value propositions for consumers and merchants. The financial institution may use the customer transaction information to track merchant store information for different store locations over a desired time.

Transaction information in database 301 may be characterized by substantial variation in entering business names in transaction data. For example, a merchant or business is often suffixed by the store number in the business name field. Consequently, identifying store numbers may be very useful in conducting analyses with an added layer of specificity. This specificity is important because knowledge of different merchants is often limited to publicly available reports.

Using store number information, analyzer 303 can internally track performance of public or private companies based on a performance metric (e.g., the same-store sales metric). A performance metric may be gauged for a store location in different ways, including the amount of sales, frequency of purchases, and the number of participating households. Based on store information, analyzer 303 can analyze local businesses and determine popular new stores, products and merchants so that a financial institution can provide targeted offerings to customers and potential customers.

Analyzer 303 may remedy a gap in internal data elements, and consequently provide improvements to existing analytics as well as create new opportunities for a financial institution.

Analyzer 303 may provide information based on merchant names, associated store numbers, geographic information, and a time element (e.g., time duration) for tracking merchants and trending analyses. Popularity and growth of this store may be measurable through transaction parameters including the transaction volume and number of households visiting the store. Consequently, analyzer 303 may provide real time insights using actual dollar spending at a store rather than relying on survey-based insights.

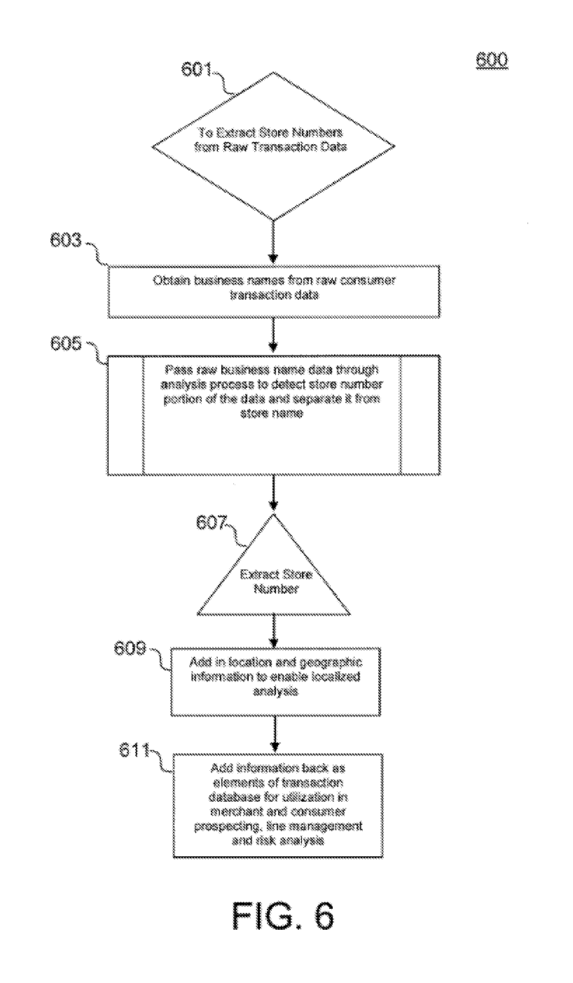

Analyzer 303 includes a merchant tracking and a geographic tool that may use an intelligent algorithm to track merchant store information over time using the database 301. Analyzer 303 may extract the associated store number from database 301 as will be further discussed with FIG. 6. Traditional systems often perform an analysis of a merchant's productivity based on their total sales rather than comparable store sales. However, total sales are typically a much looser indicator of company health.

Analyzer 303 may also utilize a geographic capability that tracks merchants by location. Analyzer 303 may utilize proprietary bank data for determining and tracking store numbers associated with different businesses in conjunction with geographic information. Consumer transaction data from database 301 may provide a wealth of information regarding consumer spending patterns at different retail stores that is not utilized with traditional systems. Using the transaction details, analyzer 303 can locate new businesses as well as specific store numbers associated with the businesses where the transactions occur.

Analyzer 303 may extract sales information with the associated store numbers of a merchant from transaction data using process 600, as shown in FIG. 6, as will be discussed. Analyzer 303 is a merchant tracking and a geographic tool that may use an intelligent algorithm to track merchant store information over time using database 301. Database 303 may store proprietary consumer transaction information of a financial institution. Analyzer 303 can track new store openings or store closings by merchant and by geography. This information may be used in detecting merchant expansion or contraction as a growth and profitability indicator of specific businesses or as a growth indicator of a local economy. Based these indicators, analyzer 303 can prospect initiatives geared towards businesses or consumers or conduct risk assessment and business credit line management. Value proposition evaluator 305 may also evaluate strategic tie-ins with local and new merchants with varied product offerings.

Analyzer 303 may support functions that include tracking comparable stores/same store spending over time. Same-store-sales measure the growth in sales of stores that have been open for a year or more. Retailers may increase their revenue either by increasing revenues at an existing store or by opening new stores to increase volumes. Rising comparable sales often mean that sales are rising at the same set of stores without the added cost of opening a new store. Same-store-sales may be a useful metric in analyzing the financial health of a merchant. Using data from database 301, analyzer 303 can track consumer spending at same stores and gauge a merchant's performance prior to financial releases. Based on this information, the financial institution can make strategic decisions regarding risk assessment and line management.

Analyzer 303 can also assist in identifying new merchants as their new stores and associated business names start to appear in transaction data. Analyzer 303 can also track merchants and store numbers that have ceased appearing in transaction data, thus indicating potential financial distress. This capability helps in identifying viable merchants that are potential customers of the financial institution. A value proposition may consequently be offered to the merchant.

Analyzer 303 can analyze store openings in conjunction with location. Analyzer 303 can keep track of new locations where a merchant may be expanding into or locations from which they are contracting. If analyzer 303 determines that new merchants are emerging or that existing merchants are opening more stores in a location, analyzer 303 may detect growth in local business or gain in popularity of a merchant's products, thus providing insights into location-based economic, demographic and social trends. Consequently, analyzer 303 provides opportunities for prospecting consumers in that location as well as developing tie-ins with the new businesses to offer different products to the consumers including debit or credit product rewards, and discount offerings.

Analyzer 303 can also detect first-mover merchants, who are often market leaders. Detecting early entrants or first providers of a new technology or product may be very useful in recognizing new and potential markets. First-movers often capture the largest market share as first entrants and are thus good candidates for tie-ins and hybrid product offerings.

Analyzer 303 can also track over time how rapidly a merchant's stores expand, multiply and sustain in order to perform a comparative analysis of growth across different kinds of merchants offering a different set of products or competing products. Such information may be useful in forecasting merchant performance, comparing competing merchants while making credit offering decisions, and making realistic assessments of a merchant's credit needs.

Analyzer 303 can analyze how rapidly a merchant loses its share as a competitor opens stores close to the merchant's stores. Conversely, analyzer 303 can detect how quickly the merchant gains market share as it opens new stores near its competitors.

Analyzer 303 can also conduct complementary store analysis. Analyzer 303 can specifically detect stores of non-competing merchants that tend to cluster together in different locations. The financial institution can then offer consumers rewards for bundling their shopping at both stores, thus enhancing transaction volume for the financial institution as it motivates consumers to shop with multiple merchants using the same payment vehicle through the bank.

Analyzer 303 can also analyze market structure and changes in industry concentration ratios as merchants in an industry open more stores and expand. Concentration ratio may be specified as the percentage of market output (revenue) generated by n largest merchants in an industry. High concentration ratios indicate lesser competition in an industry. Analyzer 303, in conjunction with industry level macro data, can analyze economic trends in an industry. The financial institution can also enter into strategic pricing decisions for product tie-ins with companies based on the knowledge of their market positions and the current industry market structure.

Analyzer 303 can also analyze if a merchant cannibalizes its own sales by opening numerous stores in the same or around the same location. While opening new stores can add to revenue, too many stores opened around the same location may be chasing the same consumers while adding to cost of maintenance, resulting in a negative impact on the merchant's profits.

Analyzer 303 can also track consumer migration. Analyzer 303 can determine whether consumers are noticeably migrating to a different store (i.e., different store number) of the merchant.

Analyzer 303 can track merger and acquisition activity and determine how new subsidiaries have improved or affected performance of a merchant. Similarly, analyzer 303 can track merchant tie-ins and determine their performance.

Analyzer 303 may be used in conjunction with the transaction recurrence engine (not explicitly shown in FIG. 3) to locate recurring transactions at a store level (corresponding to a store number). This approach provides an opportunity for recurrent transaction analysis, in which recurrent transaction trends can be compared at a store level for specific merchants. For example, system 300 may determine whether there is a store level difference in the sales of a particular product so that the financial institution can enter appropriate tie-ins.

The results of analyzer 303 can subsequently be used by evaluator 305 to evaluate different value propositions 351-357 to determine what value propositions may be offered to consumers and merchants. For example, consumers may be encouraged to generate more transactions with one or more merchants and lines of credit may be offered to credit-worthy merchants.

Different value propositions may be assessed by evaluator 305, including: line management assessment 351, merchant prospecting 352, consumer prospecting 353, customize consumer rewards 354, product tie-ins opportunities with merchants 355, cross-sell opportunities 356, and monitoring growth in local economies 357.

For example, tracked performance of a private company may be evaluated. A private company typically does not report financial returns. Evaluator 305 can identify opportunities in values propositions for line management (value proposition 351) and prospecting merchants (value proposition 352) with the added advantage of less reliance on third party reports. Also, publicly traded companies usually report their total revenues and same-store sales periodically. Tracking a merchant's performance prior to public disclosure may provide a significant opportunity for line management as well as prospecting.

Evaluator 305 can assess whether to offer targeted rewards to consumers based on how the merchant-store mix is clustered at the consumer's location. Consequently, customized reward programs (value proposition 354) may be selected based on determined metrics. Optimizing consumer satisfaction by providing consumers with customized products that cater to specific needs and shopping patterns may improve relationship with the consumers. For example, the tendency of a set of consumers to shop with store ##1 of a first merchant and store ##5 of a second merchant may indicate that these stores are potentially located in the same area or conveniently located with respect to each other. Evaluator 305 can then assess whether to offer or prospect consumers in that area with rewards when they shop at both these locations within a predetermined time duration (e.g., during the same day). This approach may ensure that a financial institution's service is utilized in a common merchant-mix of consumer purchases while enhancing transaction volumes and the footprint of the financial institution.

Consumers may also receive favorable cross sell offers based on evaluator 305 evaluation of value proposition 356. By generating cross-sell opportunities, consumers become more loyal with the institution's payment product in much of their retail purchases.

In conjunction with information on location, analyzer 303 may perform detailed location-based analyses about local economies, the structure of an industry, competition between stores or merchants, and so forth. For example, if a merchant is expanding rapidly into a location, system 300 may detect a growth in local business or increased popularity of the merchant's product, thus providing location-based insights on economic, demographic and social trends. Also, system 300 may detect if certain merchants are losing share to a competitor. These analyses may offer a great opportunity to prospect consumers (value proposition 353) in that location as well as developing tie-ins with local businesses (value proposition 355) to offer various consumer credit or debit products, discount offerings, reward products, and the like. These analyses may also assist in determining the best location for opening new ATMs as well as prospecting deposits customers based on information regarding popular stores and local economy at different locations.

Analyzer 303 may assist a financial institution (e.g., a bank) in prospecting merchants (value proposition 352) and line management and risk assessment of merchants (value proposition 351) who bank with the financial institution. For example, if a merchant has a low risk assessment with a total sales of $1,000,000 per month, a bank may offer a $1,000,000 credit line. If the merchant has a medium risk assessment, then the bank may offer only a $500,000 credit line. However, if the merchant has a high risk assessment, the bank may not offer any credit line at all.

With an aspect of the invention, system 300 enables a financial institution to partner with prospective establishments (e.g., merchants) in order to improve pricing offerings, thus enhancing profitability for the financial institution as well as for the financial institution's customers. Moreover, risk detection process may be enhanced.

With another aspect of the invention, system 300 provides a technique for locating market leaders who offer new products, e.g., providers of a new technology or a new carbon offset product. Creating tie-ins with associated businesses may secure the footprint of the financial institution in new and upcoming markets. As new markets and consumer needs evolve, system 300 enhances the capability to track trends and to enable the financial institution to stay ahead of its competition.

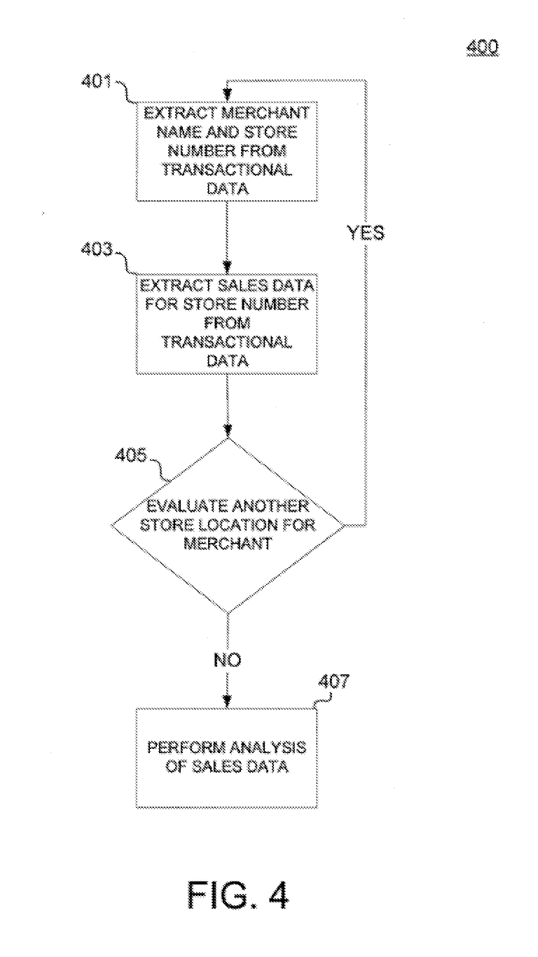

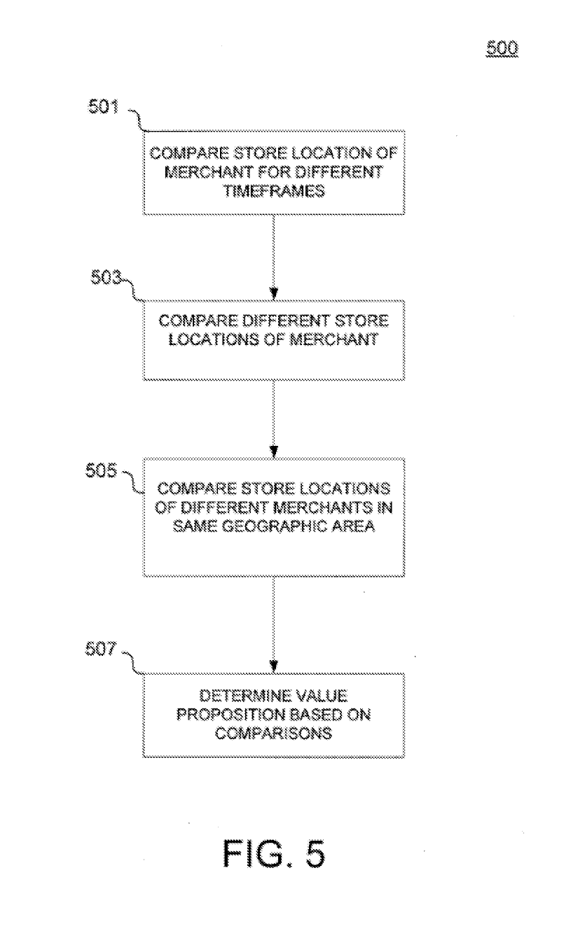

FIG. 4 shows flow diagram 400 for processing sales data for different store locations of a merchant in accordance with an aspect of the invention. In step 401, analyzer 303 accesses database 301 and extracts a merchant names and associated store numbers from accessed transaction entries (e.g., debit card, credit card, or bill payment entry). Analyzer 303 further extracts sales data, e.g., total sales, for the particular store location (as identified by the store number). Analyzer 303 determines whether sales data should be extracted for another store of the merchant in step 405. When sales data has been extracted for the different stores of the merchant, analysis of the sales data is analyzed in step 407 as further discussed in FIG. 5.

FIG. 5 shows flow diagram 500 for analyzing sales data in accordance with an aspect of the invention. In step 501, analyzer 303 compares a store location for a merchant for different timeframes in order to determine a sales trend. For example, the sales trend may be increasing when comparing one month to another. Analyzer 303 may also compare different store locations of the merchant in step 503. For example, some stores may have high sales figures while other stores have poor sales figures. A large variance for sales among the different store locations may be indicative of an underlying financial problem for the merchant. Analyzer 303 may further compare store locations for different merchants in the same geographic area in step 505. For example, large discrepancies for different merchants in the same area may indicate that one merchant is performing either poorly or well with respect to the other merchants in the area. Relative performance may be an good indicator of the merchant's financial viability. The results of the analyses in steps 501, 503, and 505 may be subsequently used by evaluator 305 to evaluate different value propositions that may be offered to merchants and consumers by the financial institution.

FIG. 6 shows flow diagram 600 for extracting store number information from transaction data in accordance with an aspect of the invention. The extracted store number then can be used by processes 400 and 500 as previously discussed. In step 601, analyzer 303 extracts store numbers and raw transaction data from transaction entries. In step 603 merchant names are identified from raw consumer transaction data (e.g., StoreName ##135). In step 605, analyzer 303 passes the raw business name data through a merchant name analysis in order to detect the store number portion and to separate it from the store name. For example, in the above example, “StoreName” is recognized as the store name while “135” is recognized as the store number. Analyzer 303 then extracts the store number in step 607. Analyzer 303 may add location and geographic information to enable localized analysis in step 609. Analyzer 303 may insert the processed information back to database 301 in step 611 in order to perform merchant and consumer prospecting and line management and risk analysis.

Aspects of the invention have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the invention.

What is claimed is:

1. A method, comprising:
accessing, by a computing system transaction data stored in a memory of the computing system, the transaction data comprising transaction data generated by a plurality of transaction-processing terminals associated with a first merchant and transaction data generated by a plurality of transaction-processing terminals associated with a second merchant;
identifying, by the computing system and from the transaction data generated by the plurality of transaction-processing terminals associated with the first merchant, transaction data for a first store location of the first merchant and transaction data for a second store location of the first merchant, wherein identifying the transaction data for the first store location of the first merchant and the transaction data for the second store location of the first merchant comprises:
identifying, by the computing system and in the transaction data generated by the plurality of transaction-processing terminals associated with the first merchant, at least one transaction entry that comprises a merchant identifier portion comprising an identifier of the first merchant and a store identifier portion comprising a store identifier associated with the first store location of the first merchant;
identifying, by the computing system and in the transaction data generated by the plurality of transaction-processing terminals associated with the first merchant, at least one transaction entry that comprises a merchant identifier portion comprising the identifier of the first merchant and a store identifier portion comprising a store identifier associated with the second store location of the first merchant;
utilizing, by the computing system, the identifier of the first merchant and the store identifier associated with the first store location of the first merchant to identify, in the transaction data generated by the plurality of transaction-processing terminals associated with the first merchant, one or more other transaction entries that comprise a merchant identifier portion comprising the identifier of the first merchant and a store identifier portion comprising the store identifier associated with the first location of the first merchant; and
utilizing, by the computing system, the identifier of the first merchant and the store identifier associated with the second location of the first merchant to identify, in the transaction data generated by the plurality of transaction-processing terminals associated with the first merchant, one or more other transaction entries that comprise a merchant identifier portion comprising the identifier of the first merchant and a store identifier portion comprising the store identifier associated with the second location of the first merchant;
identifying, by the computing system and from the transaction data generated by the plurality of transaction-processing terminals associated with the second merchant, transaction data for a first store location of the second merchant and transaction data for a second store location of the second merchant, wherein identifying the transaction data for the first store location of the second merchant and the transaction data for the second store location of the second merchant comprises:
identifying, by the computing system and in the transaction data generated by the plurality of transaction-processing terminals associated with the second merchant, at least one transaction entry that comprises a merchant identifier portion comprising an identifier of the second merchant and a store identifier portion comprising a store identifier associated with the first store location of the second merchant;
identifying, by the computing system and in the transaction data generated by the plurality of transaction-processing terminals associated with the second merchant, at least one transaction entry that comprises a merchant identifier portion comprising the identifier of the second merchant and a store identifier portion comprising a store identifier associated with the second store location of the second merchant;
utilizing, by the computing system, the identifier of the second merchant and the store identifier associated with the first store location of the second merchant to identify, in the transaction data generated by the plurality of transaction-processing terminals associated with the second merchant, one or more other transaction entries that comprise a merchant identifier portion comprising the identifier of the second merchant and a store identifier portion comprising the store identifier associated with the second location of the second merchant; and
utilizing, by the computing system, the identifier of the second merchant and the store identifier associated with the second location of the second merchant to identify, in the transaction data generated by the plurality of transaction-processing terminals associated with the second merchant, one or more other transaction entries that comprise a merchant identifier portion comprising the identifier of the second merchant and a store identifier portion comprising the store identifier associated with the second location of the second merchant;
utilizing, by the computing system, information from the transaction data for the first store location of the first merchant and information from the transaction data for the second store location of the first merchant to determine a same-store-sales performance metric for the first merchant;
utilizing, by the computing system, information from the transaction data for the first store location of the second merchant and information from the transaction data for the second store location of the second merchant to determine a same-store-sales performance metric for the second merchant;
making, by the computing system, a comparison of the same-store-sales performance metric for the first merchant and the same-store-sales performance metric for the second merchant; and
instructing, by the computing system and based on the comparison, a computing device of a financial institution to issue credit to the first merchant and not the second merchant.

2. The method of claim 1, comprising:
evaluating, by the computing system and based on the same-store-sales performance metric for the first merchant and the same-store-sales performance metric for the second merchant, each of a plurality of value propositions for the financial institution; and
selecting, by the computing system, from amongst the plurality of value propositions for the financial institution, and based on the same-store-sales performance metric for the first merchant and the same-store-sales performance metric for the second merchant, a value proposition indicating that the financial institution should issue credit to the first merchant and not the second merchant.

3. The method of claim 1, comprising determining, by the computing system and based on the transaction data stored in the memory of the computing system, that the first merchant has introduced at least one of a new technology, a new product, or a new service into a geographic area comprising the first store location of the first merchant and the first store location of the second merchant.

4. The method of claim 1, comprising determining, by the computing system and based on the transaction data stored in the memory of the computing system, a metric of economic growth for a geographic area comprising the first store location of the first merchant and the first store location of the second merchant.

5. The method of claim 1, comprising identifying, by the computing system and based on the transaction data stored in the memory of the computing system, one or more customers of the financial institution that shop at the first merchant and the second merchant.

6. The method of claim 1, comprising determining, by the computing system and based on the transaction data stored in the memory of the computing system, a geographic location, associated with at least one of the first store location of the first merchant or the second store location of the first merchant, at which to locate an automated teller machine of the financial institution.

7. The method of claim 1, comprising:
identifying, by the computing system and based on the transaction data generated by the plurality of transaction-processing terminals associated with the first merchant, a plurality of debit-card accounts, of the financial institution, charged by the first store location of the first merchant;
identifying, by the computing system and based on the transaction data generated by the plurality of transaction-processing terminals associated with the first merchant, a plurality of credit-card accounts, of the financial institution, charged by the first store location of the first merchant;
identifying, by the computing system and based on the transaction data generated by the plurality of transaction-processing terminals associated with the first merchant, a plurality of debit-card accounts, of the financial institution, charged by the second store location of the first merchant;
identifying, by the computing system and based on the transaction data generated by the plurality of transaction-processing terminals associated with the first merchant, a plurality of credit-card accounts, of the financial institution, charged by the second store location of the first merchant;
identifying, by the computing system and based on the transaction data generated by the plurality of transaction-processing terminals associated with the second merchant, a plurality of debit-card accounts, of the financial institution, charged by the first store location of the second merchant;
identifying, by the computing system and based on the transaction data generated by the plurality of transaction-processing terminals associated with the second merchant, a plurality of credit-card accounts, of the financial institution, charged by the first store location of the second merchant;
identifying, by the computing system and based on the transaction data generated by the plurality of transaction-processing terminals associated with the second merchant, a plurality of debit-card accounts, of the financial institution, charged by the second store location of the second merchant; and
identifying, by the computing system and based on the transaction data generated by the plurality of transaction-processing terminals associated with the second merchant, a plurality of credit-card accounts, of the financial institution, charged by the second store location of the second merchant.

8. A system, comprising:
a plurality of transaction-processing terminals associated with a first merchant;
a plurality of transaction-processing terminals associated with a second merchant;
a computing device of a financial institution configured to issue credit to the first merchant and the second merchant;
at least one processor; and
a memory storing instructions that when executed by the at least one processor cause the system to:
identify, in transaction data generated by the plurality of transaction-processing terminals associated with the first merchant, at least one transaction entry that comprises a merchant identifier portion comprising an identifier of the first merchant and a store identifier portion comprising a store identifier associated with a first store location of the first merchant;
identify, in the transaction data generated by the plurality of transaction-processing terminals associated with the first merchant, at least one transaction entry that comprises a merchant identifier portion comprising the identifier of the first merchant and a store identifier portion comprising a store identifier associated with a second store location of the first merchant;
identify, in the transaction data generated by the plurality of transaction-processing terminals associated with the first merchant and using the identifier of the first merchant and the store identifier associated with the first store location of the first merchant, one or more other transaction entries that comprise a merchant identifier portion comprising the identifier of the first merchant and a store identifier portion comprising the store identifier associated with the first location of the first merchant;
identify, in the transaction data generated by the plurality of transaction-processing terminals associated with the first merchant and using the identifier of the first merchant and the store identifier associated with the second store location of the first merchant, one or more other transaction entries that comprise a merchant identifier portion comprising the identifier of the first merchant and a store identifier portion comprising the store identifier associated with the second location of the first merchant;
identify, in transaction data generated by the plurality of transaction-processing terminals associated with the second merchant, at least one transaction entry that comprises a merchant identifier portion comprising an identifier of the second merchant and a store identifier portion comprising a store identifier associated with a first store location of the second merchant;
identify, in the transaction data generated by the plurality of transaction-processing terminals associated with the second merchant, at least one transaction entry that comprises a merchant identifier portion comprising the identifier of the second merchant and a store identifier portion comprising a store identifier associated with a second store location of the second merchant;
identify, in the transaction data generated by the plurality of transaction-processing terminals associated with the second merchant and using the identifier of the second merchant and the store identifier associated with the first store location of the second merchant, one or more other transaction entries that comprise a merchant identifier portion comprising the identifier of the second merchant and a store identifier portion comprising the store identifier associated with the first location of the second merchant;
identify, in the transaction data generated by the plurality of transaction-processing terminals associated with the second merchant and using the identifier of the second merchant and the store identifier associated with the second store location of the second merchant, one or more other transaction entries that comprise a merchant identifier portion comprising the identifier of the second merchant and a store identifier portion comprising the store identifier associated with the second location of the second merchant;
determine, using data from the at least one transaction entry that comprises the merchant identifier portion comprising the identifier of the first merchant and the store identifier portion comprising the store identifier associated with the first store location of the first merchant, data from the at least one transaction entry that comprises the merchant identifier portion comprising the identifier of the first merchant and the store identifier portion comprising the store identifier associated with the second store location of the first merchant, data from the one or more other transaction entries that comprise the merchant identifier portion comprising the identifier of the first merchant and the store identifier portion comprising the store identifier associated with the first location of the first merchant, and data from the one or more other transaction entries that comprise the merchant identifier portion comprising the identifier of the first merchant and the store identifier portion comprising the store identifier associated with the second location of the first merchant, a same-store-sales performance metric for the first merchant;
determine, using data from the at least one transaction entry that comprises the merchant identifier portion comprising the identifier of the second merchant and the store identifier portion comprising the store identifier associated with the first store location of the second merchant, data from the at least one transaction entry that comprises the merchant identifier portion comprising the identifier of the second merchant and the store identifier portion comprising the store identifier associated with the second store location of the second merchant, data from the one or more other transaction entries that comprise the merchant identifier portion comprising the identifier of the second merchant and the store identifier portion comprising the store identifier associated with the first location of the second merchant, and data from the one or more other transaction entries that comprise the merchant identifier portion comprising the identifier of the second merchant and the store identifier portion comprising the store identifier associated with the second location of the second merchant, a same-store-sales performance metric for the second merchant; and
instruct, based on a comparison of the same-store-sales performance metric for the first merchant and the same-store-sales performance metric for the second merchant, the computing device of the financial institution to issue credit to the first merchant and not the second merchant.

9. The system of claim 8, wherein the instructions, when executed by the at least one processor, cause the system to:
evaluate, based on the same-store-sales performance metric for the first merchant and the same-store-sales performance metric for the second merchant, each of a plurality of value propositions for the financial institution; and
select, from amongst the plurality of value propositions for the financial institution and based on the same-store-sales performance metric for the first merchant and the same-store-sales performance metric for the second merchant, a value proposition indicating that the financial institution should issue credit to the first merchant and not the second merchant.

10. The system of claim 8, wherein the instructions, when executed by the at least one processor, cause the system to determine that the first merchant has introduced at least one of a new technology, a new product, or a new service into a geographic area comprising the first store location of the first merchant and the first store location of the second merchant.

11. The system of claim 8, wherein the instructions, when executed by the at least one processor, cause the system to determine a metric of economic growth for a geographic area comprising the first store location of the first merchant and the first store location of the second merchant.

12. The system of claim 8, wherein the instructions, when executed by the at least one processor, cause the system to determine that one or more customers of the financial institution shop at the first merchant and the second merchant.

13. The system of claim 8, wherein the instructions, when executed by the at least one processor, cause the system to determine a geographic location, associated with at least one of the first store location of the first merchant or the second store location of the first merchant, at which to locate an automated teller machine of the financial institution.

14. The system of claim 8, wherein the instructions, when executed by the at least one processor, cause the system to:
identify, based on the transaction data generated by the plurality of transaction-processing terminals associated with the first merchant, a plurality of debit-card accounts, of the financial institution, charged by the first store location of the first merchant;
identify, based on the transaction data generated by the plurality of transaction-processing terminals associated with the first merchant, a plurality of credit-card accounts, of the financial institution, charged by the first store location of the first merchant;
identify, based on the transaction data generated by the plurality of transaction-processing terminals associated with the first merchant, a plurality of debit-card accounts, of the financial institution, charged by the second store location of the first merchant;
identify, based on the transaction data generated by the plurality of transaction-processing terminals associated with the first merchant, a plurality of credit-card accounts, of the financial institution, charged by the second store location of the first merchant;
identify, based on the transaction data generated by the plurality of transaction-processing terminals associated with the second merchant, a plurality of debit-card accounts, of the financial institution, charged by the first store location of the second merchant;
identify, based on the transaction data generated by the plurality of transaction-processing terminals associated with the second merchant, a plurality of credit-card accounts, of the financial institution, charged by the first store location of the second merchant;
identify, based on the transaction data generated by the plurality of transaction-processing terminals associated with the second merchant, a plurality of debit-card accounts, of the financial institution, charged by the second store location of the second merchant; and
identify, based on the transaction data generated by the plurality of transaction-processing terminals associated with the second merchant, a plurality of credit-card accounts, of the financial institution, charged by the second store location of the second merchant.

15. One or more non-transitory computer-readable media having instructions stored thereon that when executed by one or more computers cause the one or more computers to:
identify, in transaction data generated by a plurality of transaction-processing terminals associated with a first merchant, at least one transaction entry that comprises a merchant identifier portion comprising an identifier of the first merchant and a store identifier portion comprising a store identifier associated with a first store location of the first merchant;
identify, in the transaction data generated by the plurality of transaction-processing terminals associated with the first merchant, at least one transaction entry that comprises a merchant identifier portion comprising the identifier of the first merchant and a store identifier portion comprising a store identifier associated with a second store location of the first merchant;
identify, in the transaction data generated by the plurality of transaction-processing terminals associated with the first merchant and using the identifier of the first merchant and the store identifier associated with the first store location of the first merchant, one or more other transaction entries that comprise a merchant identifier portion comprising the identifier of the first merchant and a store identifier portion comprising the store identifier associated with the first location of the first merchant;
identify, in the transaction data generated by the plurality of transaction-processing terminals associated with the first merchant and using the identifier of the first merchant and the store identifier associated with the second store location of the first merchant, one or more other transaction entries that comprise a merchant identifier portion comprising the identifier of the first merchant and a store identifier portion comprising the store identifier associated with the second location of the first merchant;
identify, in transaction data generated by a plurality of transaction-processing terminals associated with a second merchant, at least one transaction entry that comprises a merchant identifier portion comprising an identifier of the second merchant and a store identifier portion comprising a store identifier associated with a first store location of the second merchant;
identify, in the transaction data generated by the plurality of transaction-processing terminals associated with the second merchant, at least one transaction entry that comprises a merchant identifier portion comprising the identifier of the second merchant and a store identifier portion comprising a store identifier associated with a second store location of the second merchant;
identify, in the transaction data generated by the plurality of transaction-processing terminals associated with the second merchant and using the identifier of the second merchant and the store identifier associated with the first store location of the second merchant, one or more other transaction entries that comprise a merchant identifier portion comprising the identifier of the second merchant and a store identifier portion comprising the store identifier associated with the first location of the second merchant;
identify, in the transaction data generated by the plurality of transaction-processing terminals associated with the second merchant and using the identifier of the second merchant and the store identifier associated with the second store location of the second merchant, one or more other transaction entries that comprise a merchant identifier portion comprising the identifier of the second merchant and a store identifier portion comprising the store identifier associated with the second location of the second merchant;
determine, using data from the at least one transaction entry that comprises the merchant identifier portion comprising the identifier of the first merchant and the store identifier portion comprising the store identifier associated with the first store location of the first merchant, data from the at least one transaction entry that comprises the merchant identifier portion comprising the identifier of the first merchant and the store identifier portion comprising the store identifier associated with the second store location of the first merchant, data from the one or more other transaction entries that comprise the merchant identifier portion comprising the identifier of the first merchant and the store identifier portion comprising the store identifier associated with the first location of the first merchant, and data from the one or more other transaction entries that comprise the merchant identifier portion comprising the identifier of the first merchant and the store identifier portion comprising the store identifier associated with the second location of the first merchant, a same-store-sales performance metric for the first merchant;
determine, using data from the at least one transaction entry that comprises the merchant identifier portion comprising the identifier of the second merchant and the store identifier portion comprising the store identifier associated with the first store location of the second merchant, data from the at least one transaction entry that comprises the merchant identifier portion comprising the identifier of the second merchant and the store identifier portion comprising the store identifier associated with the second store location of the second merchant, data from the one or more other transaction entries that comprise the merchant identifier portion comprising the identifier of the second merchant and the store identifier portion comprising the store identifier associated with the first location of the second merchant, and data from the one or more other transaction entries that comprise the merchant identifier portion comprising the identifier of the second merchant and the store identifier portion comprising the store identifier associated with the second location of the second merchant, a same-store-sales performance metric for the second merchant; and
instruct, based on a comparison of the same-store-sales performance metric for the first merchant and the same-store-sales performance metric for the second merchant, a computing device of a financial institution to issue credit to the first merchant and not the second merchant.

16. The one or more non-transitory computer-readable media of claim 15, wherein the instructions, when executed by the one or more computers, cause the one or more computers to:
evaluate, based on the same-store-sales performance metric for the first merchant and the same-store-sales performance metric for the second merchant, each of a plurality of value propositions for the financial institution; and
select, from amongst the plurality of value propositions for the financial institution and based on the same-store-sales performance metric for the first merchant and the same-store-sales performance metric for the second merchant, a value proposition indicating that the financial institution should issue credit to the first merchant and not the second merchant.

17. The one or more non-transitory computer-readable media of claim 15, wherein the instructions, when executed by the one or more computers, cause the one or more computers to determine that the first merchant has introduced at least one of a new technology, a new product, or a new service into a geographic area comprising the first store location of the first merchant and the first store location of the second merchant.

18. The one or more non-transitory computer-readable media of claim 15, wherein the instructions, when executed by the one or more computers, cause the one or more computers to determine that one or more customers of the financial institution shop at the first merchant and the second merchant.

19. The one or more non-transitory computer-readable media of claim 15, wherein the instructions, when executed by the one or more computers, cause the one or more computers to determine a geographic location, associated with at least one of the first store location of the first merchant or the second store location of the first merchant, at which to locate an automated teller machine of the financial institution.

20. The one or more non-transitory computer-readable media of claim 15, wherein the instructions, when executed by the one or more computers, cause the one or more computers to:
identify, based on the transaction data generated by the plurality of transaction-processing terminals associated with the first merchant, a plurality of debit-card accounts, of the financial institution, charged by the first store location of the first merchant;
identify, based on the transaction data generated by the plurality of transaction-processing terminals associated with the first merchant, a plurality of credit-card accounts, of the financial institution, charged by the first store location of the first merchant;
identify, based on the transaction data generated by the plurality of transaction-processing terminals associated with the first merchant, a plurality of debit-card accounts, of the financial institution, charged by the second store location of the first merchant;
identify, based on the transaction data generated by the plurality of transaction-processing terminals associated with the first merchant, a plurality of credit-card accounts, of the financial institution, charged by the second store location of the first merchant;
identify, based on the transaction data generated by the plurality of transaction-processing terminals associated with the second merchant, a plurality of debit-card accounts, of the financial institution, charged by the first store location of the second merchant;
identify, based on the transaction data generated by the plurality of transaction-processing terminals associated with the second merchant, a plurality of credit-card accounts, of the financial institution, charged by the first store location of the second merchant;
identify, based on the transaction data generated by the plurality of transaction-processing terminals associated with the second merchant, a plurality of debit-card accounts, of the financial institution, charged by the second store location of the second merchant; and
identify, based on the transaction data generated by the plurality of transaction-processing terminals associated with the second merchant, a plurality of credit-card accounts, of the financial institution, charged by the second store location of the second merchant.
